(19) United States
(12) Patent Application Publication
(10) Pub. No.: US 2018/0278092 A1
(43) Pub. Date: Sep. 27, 2018

(54) NON-CONTACT POWER TRANSMISSION APPARATUS AND POWER SUPPLY DEVICE

(71) Applicant: TOSHIBA TEC KABUSHIKI KAISHA, Tokyo (JP)

(72) Inventors: Takuya Ogishima, Izu Shizuoka (JP); Masakazu Kato, Numazu Shizuoka (JP)

(73) Assignee: TOSHIBA TEC KABUSHIKI KAISHA, Tokyo (JP)

(21) Appl. No.: 15/909,922

(22) Filed: Mar. 1, 2018

(30) Foreign Application Priority Data
Mar. 23, 2017 (JP) 2017-057962

(51) Int. Cl. H02J 50/10; H02J 7/00; H04B 5/00

(52) U.S. Cl. CPC H02J 50/10; H02J 7/0045; H04B 5/0081; H04B 5/0037; H02J 7/0027

(57) ABSTRACT

A non-contact power transmission apparatus includes a device including a power reception coil arranged to generate an induced current by magnetic flux in a first direction crossing a gravity direction. An outer shape of a first coil pattern has a first width in a second direction crossing the first direction and the gravity direction. The apparatus includes a power supply device including a power transmission coil arranged to generate the magnetic flux in the first direction. An outer shape of a second coil pattern has a second width larger than the first width in the second direction. A support section is configured to support a second insulating substrate in parallel with a first insulating substrate. A conductive housing has the power transmission coil and the support section and has an opening to which the device can be inserted.

### CROSS-REFERENCE TO RELATED APPLICATION

This application claims the benefit of and priority to Japanese Patent Application No. 2017-057962, filed Mar. 23, 2017, the entire contents of which are incorporated herein by reference.

### FIELD

Embodiments described herein relate generally to a non-contact power transmission apparatus used in a device such as a portable type thermal recording apparatus.

### BACKGROUND

A portable terminal apparatus such as a smartphone has a rechargeable secondary battery therein. An AC adapter for charging is connected to the portable terminal apparatus by wire and charges the secondary battery. In recent years, the portable terminal apparatus has a non-contact charging function. The portable terminal apparatus has a power reception coil for receiving electric power, a power reception circuit for generating electric power through the power reception coil, and a charging circuit for charging a secondary battery to realize the non-contact charging function. The non-contact charging function uses non-contact power transmission that transmits the electric power in a non-contact manner from the power transmission coil and receives the electric power with the power reception coil.

In the non-contact power transmission, a method in which the electric power is transmitted by electromagnetic induction between the power transmission coil provided in the power supply device and the power reception coil provided in the portable terminal apparatus has become widespread. A frequency band used in the electromagnetic induction is about 100 kHz to 200 kHz. A charging stand provided with a non-contact power transmission function is known. A surface of the portable terminal apparatus has a planar shape, and thus an upper surface on which the portable terminal apparatus is placed of the charging stand, which is the power supply device, also has a planer shape. If the portable terminal apparatus is placed at an arbitrary position on the upper surface of the charging stand, the charging stand detects the position of the portable terminal apparatus, moves the power transmission coil so that the power transmission coil and the power reception coil have an optimal positional relationship to charge the portable terminal apparatus. Further, fine adjustment of the position is performed during the charging, thereby improving power transmission efficiency.

A non-contact charging device is not limited to being applied to the portable terminal apparatus having a thin shape such as a smartphone. It is also possible to use a non-contact charging device to charge the secondary battery built in the portable terminal apparatus and an electronic equipment in the portable terminal apparatus where the electronic equipment has a certain thickness and further includes protrusions. For example, the non-contact charging device way also be used for a toy, a box-shaped portable type electronic equipment such as a portable type printer or a portable type video camera, or the like. There is also a charging stand that charges a plurality of these devices collectively.

### DESCRIPTION OF THE DRAWINGS

FIG. 1 is a block diagram of a non-contact power transmission apparatus according to a first embodiment;

FIG. 2 is an external view of a portable type thermal recording apparatus according to the first embodiment;

FIG. 3 is a diagram illustrating the inside of the portable type thermal recording apparatus according to the first embodiment;

FIG. 4 is a diagram illustrating a recording section and a thermal recording paper of the portable type thermal recording apparatus according to the first embodiment;

FIG. 5 is an external view of a charging box according to the first embodiment;

FIG. 6 is a diagram illustrating the internal configuration of the charging box according to the first embodiment;

FIG. 7 is a cross sectional view illustrating the internal configuration of the charging box according to the first embodiment;

FIG. 8 is a diagram illustrating an example of coil arrangement according to the first embodiment;

FIG. 9 is a graph illustrating the relationship between a distance between a power transmission coil and a power reception coil and received power;

FIG. 10 is a diagram illustrating a non-contact power transmission apparatus according to a second embodiment; and

FIG. 11 is a diagram illustrating a non-contact power transmission apparatus according to a third embodiment.

### DETAILED DESCRIPTION

According to some embodiments of the present invention, a non-contact power transmission apparatus comprises a device including a first insulating substrate formed into a planar shape and having a first conductive layer on a surface thereof, and a power reception coil which uses the first conductive layer as a first coil pattern and is arranged to generate induced current by magnetic flux in a first direction crossing a gravity direction, and an outer shape of the first coil pattern having a first width in a second direction crossing the first direction and the gravity direction; and a power supply device including a second insulating substrate formed into a planar shape and having a second conductive layer on a surface thereof, a power transmission coil which uses the second conductive layer as a second coil pattern, and is arranged to generate the magnetic flux in the first direction, an outer shape of the second coil pattern having a second width larger than the first width in the second direction, a support section configured to support the second insulating substrate in parallel with the first insulating substrate, and a conductive housing having the power transmission coil and the support section and having an opening to which the device can be inserted.

Hereinafter, an embodiment will be described with reference to accompanying drawings. In the drawings, the same configuration is denoted with the same reference numerals.

The non-contact power transmission apparatus is composed of a power supply device and a device comprising a power reception device. In the present embodiment, a portable type thermal recording apparatus is exemplified as the device. The portable type thermal recording apparatus is a small printing apparatus which is easy to carry. Detailed description is made below.

### FIRST EMBODIMENT

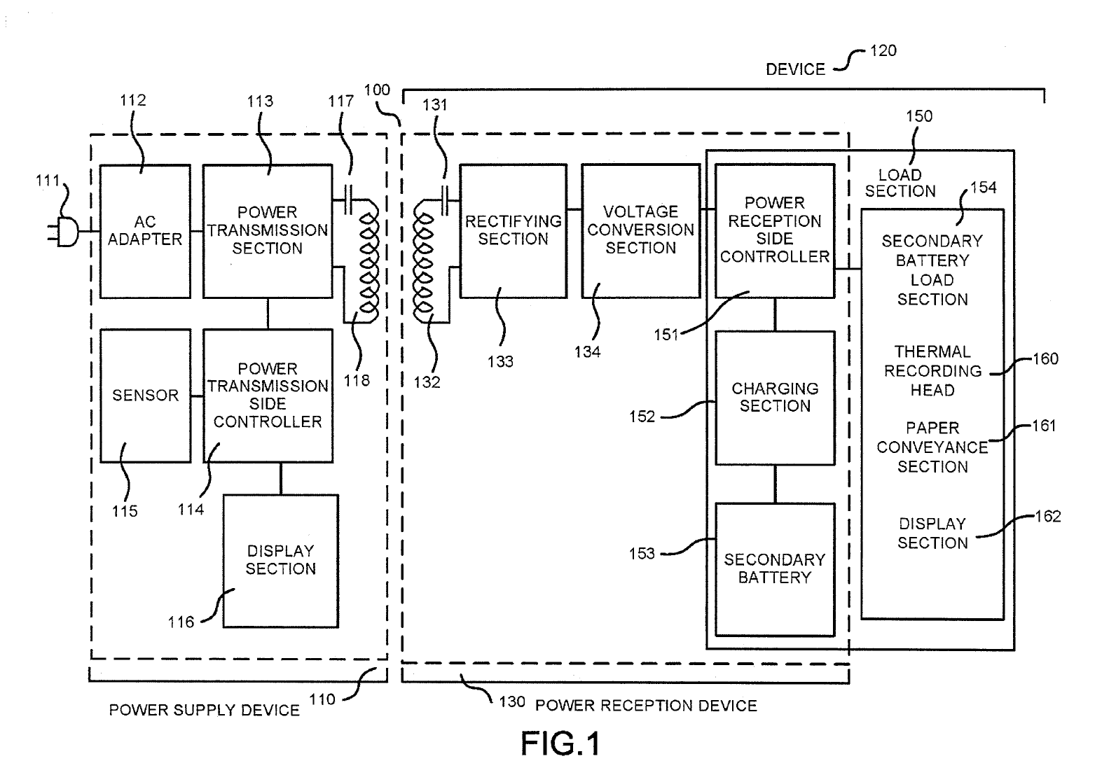

As shown in FIG. 1, a non-contact power transmission apparatus 100 is composed of a power supply device 110 and a power reception device 130 which is provided in a device 120. FIG. 1 is a block diagram illustrating the circuit configuration of the power supply device 110 and the power reception device 130. The device 120 is a portable type thermal recording apparatus. The portable type thermal recording apparatus 120 is provided with a charging section 152 which receives electric power from the power supply device 110 and charges a secondary battery 153 in a non-contact manner.

The power supply device 110 is connected to an AC power source of 100 V via a plug 111. The power supply device 110 includes an AC adapter 112, a power transmission section 113, a power transmission side controller 114, a sensor 115, and a display section 116.

The AC adapter 112 converts AC power input via the plug 111 to DC power. The DC power is used to drive the power transmission side controller 114 and the power transmission section 113. The power transmission section 113 is used for generating transmission power necessary for transmitting the electric power to the power reception device 130. The power transmission side controller 114 has a microcomputer for controlling the power supply device 110 and an oscillation circuit for generating a power carrier wave for power transmission. The microcomputer may include, for example, a CPU (Central Processing Unit), a RAM (Random Access Memory), a ROM (Read Only Memory), and an I/O (Input/Output) port. The carrier wave for non-contact power transmission is 6.78 MHz. The sensor 115 is a limit switch, a pressure sensor, or the like. The sensor 115 detects a distance between the power supply device 110 and the power reception device 130. The display section 116 is a light emitting diode (LED) or a liquid crystal. Based on a detection result of the sensor 115, if the power reception device 130 is placed at an appropriate position with respect to the power supply device 110, the LED is lit. If the secondary battery built in the power reception device 130 is fully charged, the LED is turned off. If the power reception device 130 is moved away from the power supply device 110, the LED flashes. A power transmission capacitor 117 and a power transmission coil 118 are connected in series to the power transmission section 113. A resonance circuit constituted by the power transmission capacitor 117 and the power transmission coil 118 generates AC power having the same or substantially the same frequency as a self resonance frequency.

The frequency of the AC power generated by the power supply device 110 is a frequency of about 100 kHz if an electromagnetic induction system is used for the power transmission, and is several MHz to tens of MHz if a magnetic field resonance system is used for the power transmission. Specifically, in the case of the magnetic resonance system, 6.78 MHz or 13.56 MHz is used in many cases. In the present embodiment, 6.78 MHz is used. In the present embodiment, an operating frequency is not limited, and it can be used in a wide frequency band such as a electromagnetic induction system and a magnetic field resonance system.

In order to transmit the electric power with high efficiency, the power transmission section 113 is a D-class amplifier circuit by a switching circuit. A switching element used for the switching circuit is a MOSFET (Metal-Oxide-Semiconductor Field Effect Transistor). Instead of the D-class amplifier circuit, an E-class amplifier circuit can also be used. Instead of MOSFET, it is also possible to use GaN FET (gallium nitride FET) for high frequency switching.

The device 120 includes a power reception device 130 which receives the electric power transmitted from the power supply device 110 and a load section 150 which operates by the received electric power. In the present embodiment, the load section 150 is the secondary battery and a portable type thermal recording apparatus including the secondary battery.

The power reception, device 130 is part of the portable type thermal recording apparatus (device) 120. The power reception device 130 includes a resonance circuit formed by a resonance capacitor 131 (power reception capacitor) and a resonance coil 132 (power reception coil) connected in series, a rectifying section 133, a voltage conversion section 134, a power reception side controller 151, a charging section 152, and a secondary battery 153. The power reception side controller 151, the charging section 152, and the secondary battery 153 are also the load section 150 of the portable type thermal recording apparatus (device) 120. The load section 150 further has a secondary battery load section 154. The secondary battery load section 154 is a thermal recording head 160, a paper conveyance section 161, a display section 162, and the like.

The power reception capacitor 131 and the power reception coil 132 connected in series in the power reception device 130 are set to values that resonate at 6.78 MHz. The electromagnetic wave transmitted by a resonance circuit composed of a power transmission capacitor 117 and a power transmission coil 118 of the power supply device generates an induced current in the power reception coil 132, and resonates at the power reception capacitor 131 and the power reception coil 132. The electric power is generated by the resonance of the power reception device. The power reception capacitor 131 and the power reception coil 132 are connected to the rectifying section 133. The rectifying section 133 converts the AC power transmitted at 6.78 MHz to the DC power. The voltage conversion section 134 converts a voltage converted to the DC voltage in the rectifying section 133 to a voltage that operates each part of the load section 150.

The power reception side controller 151 controls the charging section 152, the thermal recording head 160, the paper conveyance section 161, and the display section 162. The charging section 152 charges the secondary battery 153 with the electric power obtained from the voltage conversion section 134. The electric power obtained via the power reception capacitor 131 and the power reception coil 132 is used for the operation of the power reception side controller 151 and charging of the secondary battery 153, and is also used to operate the thermal recording head 160, the paper conveyance section 161 and the display section 162.

The self resonance frequency of the resonance circuit composed of the power reception coil 132 and the power reception capacitor 131 of the power reception device 130 is the same or substantially the same as the self resonance frequency of the resonance circuit composed of the power transmission coil 118 and the power transmission capacitor 117 of the power supply device 110. As the frequencies are the same, both resonance circuits are electromagnetically coupled to each other to transmit the electric power efficiently from the power transmission side to the power reception side.

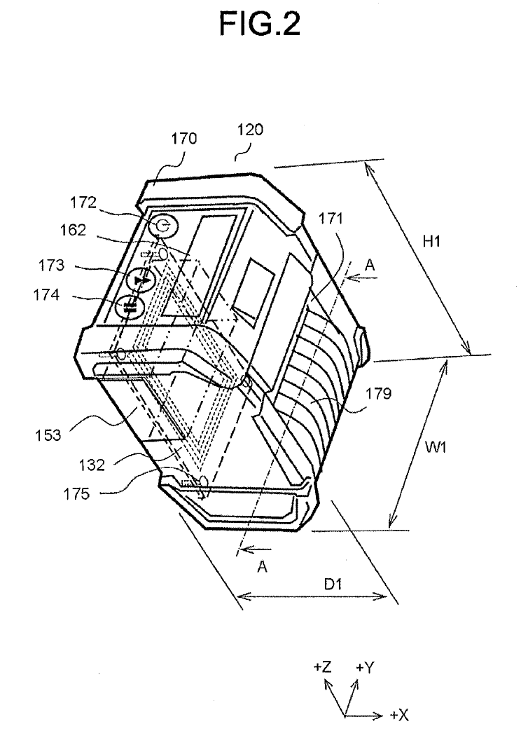

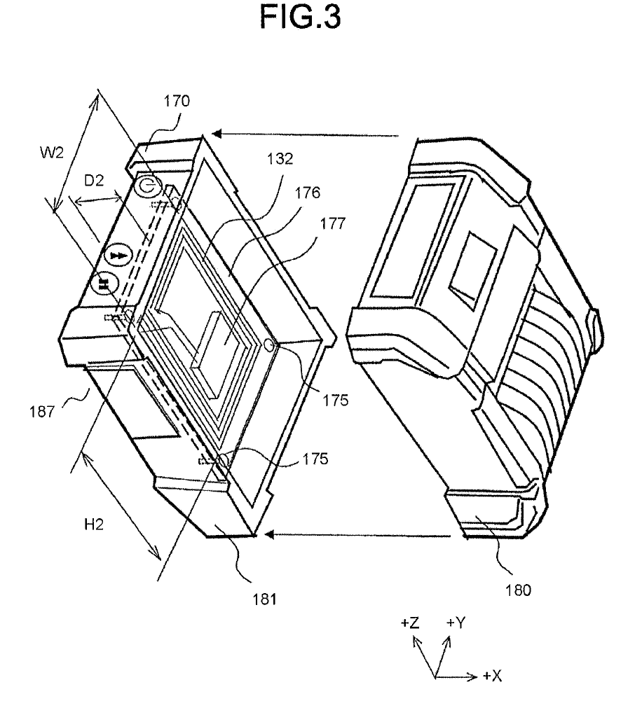

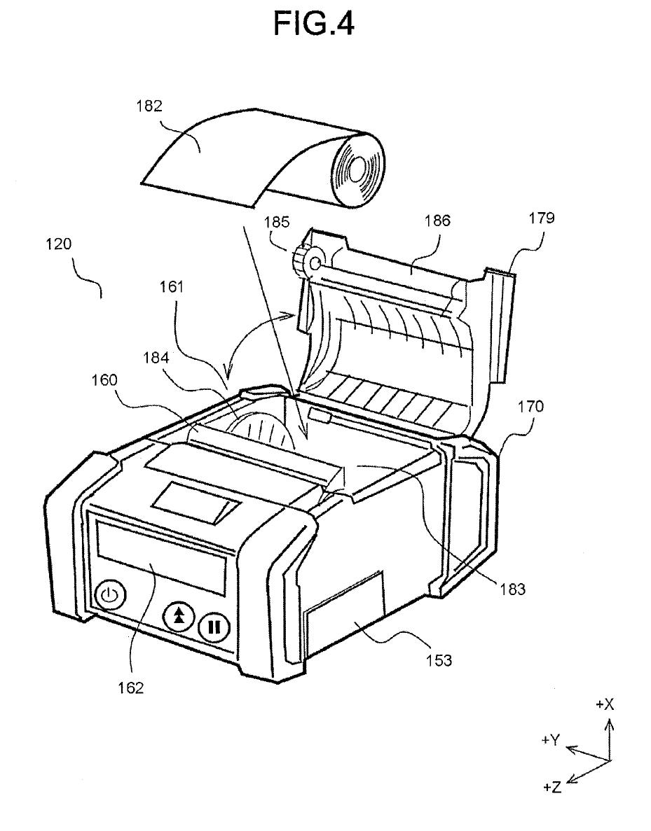

FIG. 2 shows the outline of the portable type thermal recording apparatus 120. FIG. 3 shows the portable type thermal recording apparatus 120 divided along an A-A line in FIG. 2. In FIG. 3, the power reception coil 132 fixed to a housing 170 is shown. FIG. 4 shows a state in which a cover 179 of the portable type thermal recording apparatus 120 is opened. A winding paper 182 is a thermal recording paper having a width of 50 mm and is accommodated in the housing 170. The portable type thermal recording apparatus 120 corresponds to the device 120 shown in FIG. 1 and includes the power reception device 130 and the load section 150.

In FIG. 2, a Z axis indicates a gravity direction. The outer shape of the housing 170 has a height H1 (120 mm) in the Z axis direction, a width W1 (90 mm) in the Y axis direction, and a depth D1 (70 mm) in the X axis direction. The portable type thermal recording apparatus 120 is provided with the cover 179 at the upper part in the X axis direction. The cover 179 also functions as a discharge port 171 of the thermal recording paper 182 after printing. A power source switch 172, a paper feed switch 173, and a pause switch 174 are provided on the front surface in the Z axis direction. From the side surface in the Y axis direction, the secondary battery 153 can be inserted into the housing 170. The power reception coil 132 is provided in the portable type thermal recording apparatus 120.

FIG. 3 shows an upper part 180 and a lower part 181 obtained by dividing the portable type thermal recording apparatus 120 along the A-A line as shown in FIG. 2. In the lower part 181 of the housing 170, a PC (Printed Circuit) board 176 on which a pattern of the power reception coil 132 is formed is provided. The PC board 176 may be a glass epoxy board. The pattern of the power reception coil 132 is made of copper foil on the PC board 176. The power reception coil 132 has two-turn spiral pattern having a height H2 (60 mm) and a width W2 (45 mm). The PC board 176 may be held in the housing 170 with screws 175. The power reception coil 132 is provided parallel to a bottom surface 187 at a distance D2 (6 mm) from an end of the housing 170. If the portable type thermal recording apparatus 120 is placed on an X-Y plane, the power reception coil 132 is provided parallel to a Y-Z plane. If the power reception coil 132 is arranged parallel to the Y-Z plane and receives a magnetic flux in the X axis direction, the power reception coil 132 generates an induced current. In other words, the power reception coil 132 receives the magnetic flux in a direction orthogonal to the gravity direction to generate the induced current. The power reception coil 132 and the power reception capacitor 131 generate an induced current of 6.78 MHz.

The pattern end of the power reception coil 132 is connected to a circuit 177 including the power reception capacitor 131 and the rectifying section 133. The voltage conversion section 134 is arranged in the upper part 180 and is electrically connected to the power reception side controller 151 and the charging section 152.

The number of spirals of the power reception coil 132 is determined in consideration of the capacity of the power reception capacitor and the resonance frequency. The pattern of the power reception coil 132 can have a circular or elliptical shape.

FIG. 4 shows a state in which the cover 179 of the portable type thermal recording apparatus 120 is opened. The cover 179 is opened and the wound thermal recording paper 182 is inserted into a paper holding section 183 of the housing 170. The portable type thermal recording apparatus 120 has the thermal recording head 160 for performing printing on a thermal paper, and the paper conveyance section 161 for supplying the thermal recording paper 182 to the thermal recording head 160. The paper conveyance section 161 includes a gear 184 rotated by a motor (not shown), a gear 185 engaged with the gear 184, and a platen roller 186. The platen roller 186 is rotated by the gear 185 to convey the thermal paper. According to print data, the power reception side controller 151 performs control to print on the conveyed thermal paper with the thermal recording head 160.

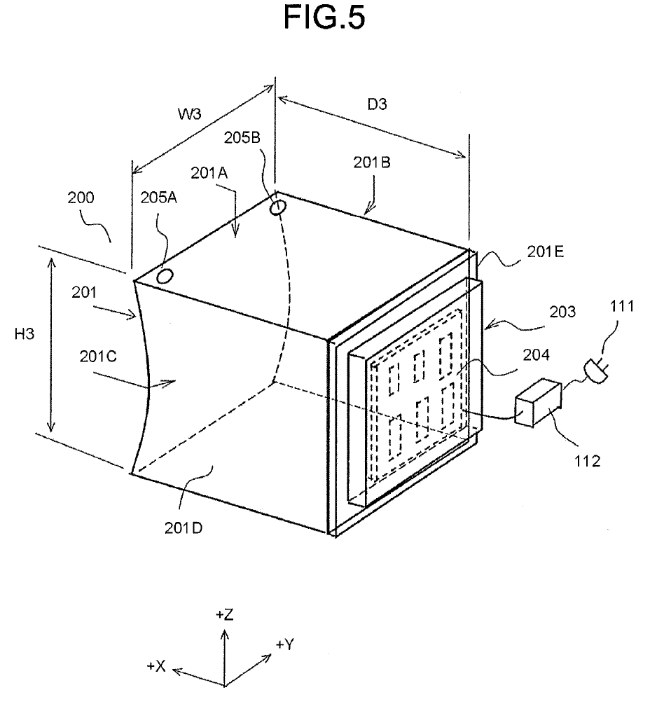

FIG. 5 shows a charging box 200 loaded with the power supply device 110 and transmitting the electric power in a non-contact manner. The charging box 200 is surrounded by housing surfaces 201A, 201B, 201C, 201D and 201E. The housing surfaces (201A to 201E) may be made of a stainless plate with a thickness of 0.1 mm. A part of the charging box 200 is an opening 201 for accommodating the portable type thermal recording apparatus 120. The housing surface 201A is an upper surface, the housing surface 201B and 201C are side surfaces, the housing surface 201D is an installation surface of the charging box 200, and the housing surface 201E is a rear surface (back surface). The housing surface 201E is provided with a casing 203 made of stainless steel, and the power supply device 110 is provided in the casing 203. The PC board 204 is loaded with circuit components and the power transmission capacitor 117 of the power supply device 110. The AC adapter 112 is externally attached. The outer shape of the charging box 200 has a height H3 (150 mm) in the Z axis direction, a width W3 (150 mm) in the Y axis direction, and a depth D3 (140 mm) in the X axis direction. The charging box 200 has a shape that facilitates insertion of the portable type thermal recording apparatus 120. On the housing surface 201A which is the upper surface of the charging box 200, LEDs 205A and 205B are provided. The LEDs 205A and 205B are disposed at both ends in the Y axis direction in the vicinity of the opening 201.

The charging box 200 is made of a metal material having high conductivity in order to prevent radio wave leakage. In addition to the stainless steel, aluminum, copper, or the like cam be also used as the metal material.

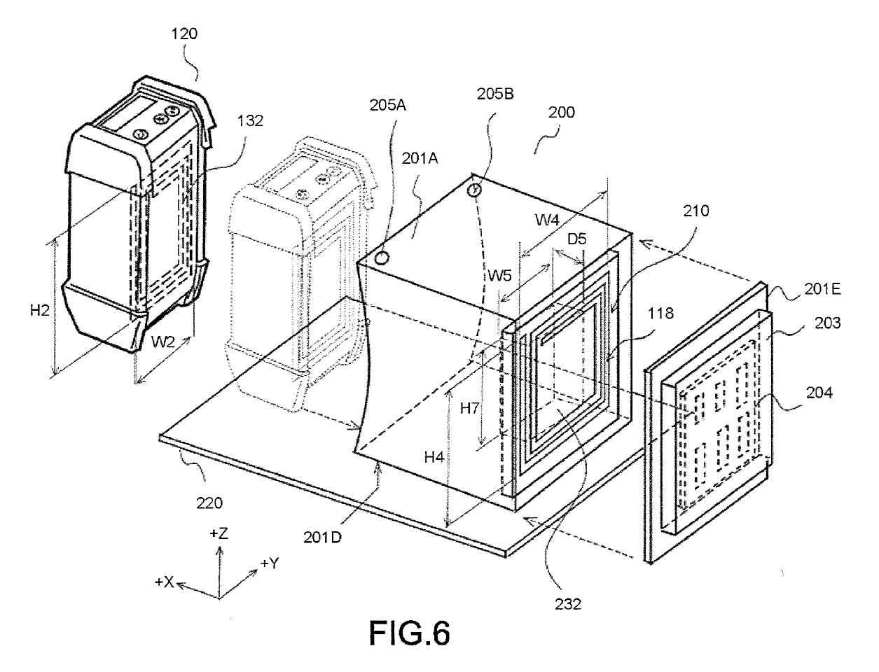

FIG. 6 shows the charging box 200 placed on a placing surface 220 and the portable type thermal recording apparatus 120 inserted into the charging box 200 for the non-contact charging. In order to easily describe the internal configuration of the charging box 200, the housing surface 201E is separated from the housing surfaces (201A to 201D). The power transmission roil 118 is arranged inside the charging box 200 at the housing surface 201E side. A support section 234 for supporting the power transmission coil 118 is provided on a surface in the charging box 200 of the housing surface 201E. The support section 234 may be made of insulating resin. The power transmission coil 118 is formed by a copper foil pattern on a PC board 210 made of glass epoxy and has a planar shape. The power transmission coil 118 has two-turn spiral pattern having a height H4 (60 mm) in the Z axis direction and a width W4 (55 mm) in the Y axis direction. An end of the pattern of the power transmission coil 118 is connected to the power transmission capacitor 117 via a wiring 206.

The power transmission coil 118 is a two-turn pattern with the height H4 and the width W4, and the power reception coil 132 is a two-turn pattern with the height H2 and the width W2. Further, the heights H4 and H2 are the same value, and the width W4 is larger than the width W2. The width W2 of the power reception coil in the Y axis direction is smaller than the width W4 of the power transmission coil 118 in the Y axis direction. At the opening 201 side of the PC board 210, a spacer 232 is provided. The spacer may be made of resin and have a thickness of (D5) 12 mm,, a height (H7) of 40 mm, and a width (W5) of 40 mm. There is a possibility that the center of the power transmission coil 118 and the center of the power reception coil 132 are slightly misaligned in the Y axis direction when the portable type thermal recording apparatus 120 is inserted into the charging box 200. By setting the width W4 to a value larger than the width W2, even if a position deviation occurs in the Y axis direction, it is possible to transmit the electric power from the power transmission coil 118 to the power reception coil 132 while maintaining the power transmission efficiency.

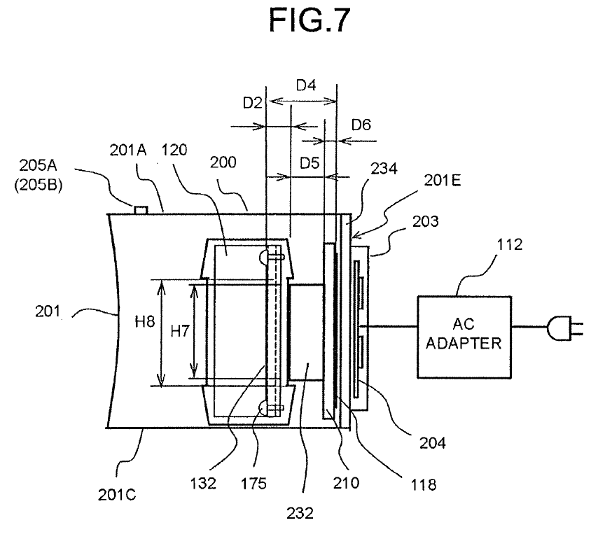

FIG. 7 shows the cross-section of the portable type thermal recording apparatus 120 and the charging box 200. The PC board 210 has a thickness (D6) of 2 mm. The portable type thermal recording apparatus 120 is inserted from the opening 201 and pushed until it contacts the spacer 232. The spacer 232 contacts the bottom surface 187 (height (H8) 45 mm) of the portable type thermal recording apparatus 120. As a result, a distance D4 between the power transmission coil 118 and the power reception coil 132 is kept constant. The distance D4 is set to 20 mm. The spacer 232 contacts with the housing of the portable type thermal recording apparatus 120 and keeps the distance D4 at an appropriate value.

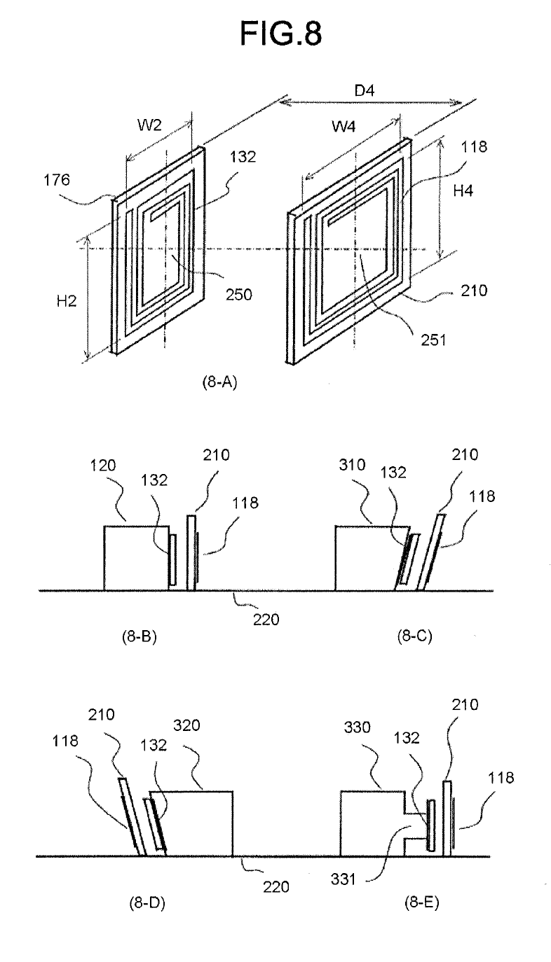

FIG. 8 (8-A) shows the arrangement of the power reception coil 132 formed on the PC board 176 and the power transmission coil 118 formed on the PC board 210. The surface of the PC board 176 on which the power reception coil 132 is provided and the surface of the PC board 210 on which the power transmission coil 118 is provided are parallel to each other at the distance D4. The surfaces of the PC boards 176 and 210 are arranged so as to be orthogonal to the gravity direction. Preferably, a center 250 of the power reception coil 132 and a center 251 of the power transmission coil 118 are positioned on substantially the same line. When the user inserts the portable type thermal recording apparatus 120 into the opaque charging box 200, it is not possible to visually align the center 250 of the power reception coil 132 and the center 251 of the power transmission coil 118. Even if the portable type thermal recording apparatus 120 is inserted into the charging box 200 while slight position deviation occurs in the Y axis direction, it is possible to transmit the electric power while maintaining the power transmission efficiency in the configuration of the present embodiment.

FIG. 8 (8-B) is a schematic diagram illustrating an example in which the power reception coil 132 and the power transmission coil 118 are arranged as described above. If the power reception coil 132 and the power transmission coil 118 are kept parallel, each coil (132, 118) is not necessarily orthogonal to the installation surface 220. In FIG. 8 (8-C) and. FIG. 8 (8-D), the power reception coil 132 and the power transmission coil 118 of each of devices 310 and 320 are arranged in parallel and slightly inclined with respect to the installation surface. FIG. 8 (8-E) shows a configuration in which a device 330 has a protrusion 331 and the power reception coil 132 is disposed on the protrusion 331. It is possible to configure the device 330 and the charging box 200 in such a manner that the power reception coil 132 and the power transmission coil 118 are parallel to each other and keep the distance D4 therebetween even if the device 330 includes the protrusion 331. In FIG. 8 (8-B) to FIG. 8 (8-E), the spacer 232 is omitted.

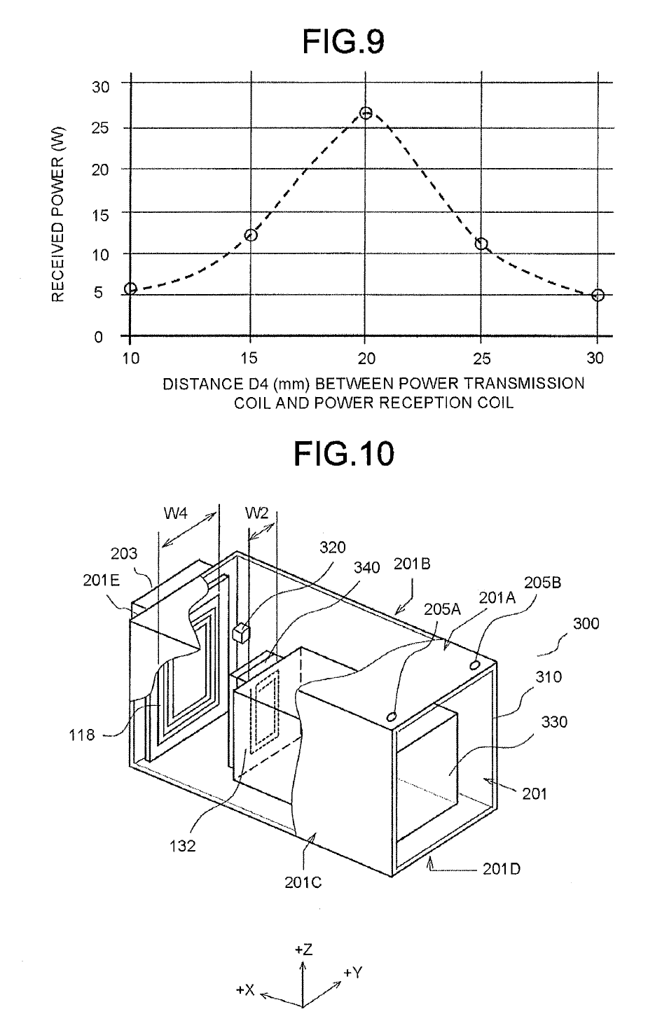

FIG. 9 shows an example of the distance D4 between the power transmission coil 118 and the power reception coil 132 and a received power (W) obtained by the power reception device. A horizontal axis snows the distance D4 between the power transmission coil 118 and the power reception coil 132. A vertical axis shows the received power (W). It is possible to transmit the electric power with the distance D4 between 10 mm and 30 mm. If the distance D4 is from 17 mm to 23 mm, the received power of 20 W or more can be received, which is a preferable range. If the distance D4 is 20 mm, the received power is 26 (W), which is the maximum. As described above, by enabling the PC board 210 including the power transmission coil 118 and the spacer 232 to abut against the side surface of the portable type thermal recording apparatus 120, it is possible to optimize the distance D4.

By setting the height (H3) of the charging box 200 matching the height (H1) of the portable type thermal recording apparatus 120, it is possible to suppress a non-contact charging device 50 from becoming tall. Since the charging box 200 is made of the metal material, the charging box 200 absorbs noise, so it is possible to reduce radiation noise.

The outer surfaces (201A, 201B, 201C, 201D, 201E) of the charging box 200 are made of the metal material and are opaque so that the inside of the charging box 200 cannot be visually observed. Since a contact state between the portable type thermal recording apparatus 120 and the spacer 232 cannot be visually observed, whether the portable type thermal recording apparatus 120 and the power transmission coil 118 are facing each other at an appropriate distance cannot be confirmed. The width of the power reception coil 132 is smaller than that of the power transmission coil 118. Therefore, when the portable type thermal recording apparatus 120 is inserted into the charging box 200 from the opening 201, even if the center 251 of the power transmission coil and the center 250 of the power reception coil are slightly misaligned in the horizontal direction (Y axis direction), it is possible to keep the distance D4 constant while maintaining the power transmission coil and the power reception coil parallel to each other. Therefore, it is possible to transmit the electric power with high efficiency by maintaining the resonance of the power supply device and the power reception device.

### SECOND EMBODIMENT

FIG. 10 shows the non-contact power transmission apparatus 300 according to the second embodiment. A charging box 310 has an opening 201 for accommodating the device 330. The housing surface 201A of the charging box 310 is an upper surface, the housing surface 201B and 201C are side surfaces, the housing surface 201D is an installation surface of the charging box 310, the housing surface 201E is a rear surface (back surface). Each of the housing surfaces (201A to 201E) may be made of stainless steel. The housing surface 201E is provided with the casing 203 made of stainless steel, and the power supply device 110 is provided in the casing 203. On the housing surface 201A, as the display section, LEDs 205A and 205B are provided. The LEDs 205A and 205B are disposed at both ends in the Y axis direction in the vicinity of the opening 201. At the inner surface of the charging box 310, an optical sensor 320 is provided on the housing surface 201B between the housing surface 201E and the device 330. The device 330 includes a spacer 340 that maintains the distance between the power reception coil 132 and the power transmission coil 118. The spacer 340 may be made of resin. The spacer 340 has an area larger than the power reception coil 132 so as to keep insulation of the power reception coil 132 and keep the distance to the power transmission coil 118 constant. The power reception coil 132 is connected to the power reception capacitor 131 in the device and resonates at 6.78 MHz. The power transmission coil 118 is also connected to the power transmission capacitor 117 and resonates at 6.78 MHz.

The optical sensor 320 detects the presence or absence of the device 330 by reflection of light. At the time of observing the charging box 310 from the opening 201 side, the optical sensor 320 is arranged at a position where it does not obstruct insertion of the device 330 and the state thereof changes when the power transmission coil 118 and the power reception coil 132 (spacer 340) contact with each other. For example, since the width W4 of the power transmission coil 118 is greater than the width W2 of the power reception coil 132, the optical sensor 320 can operate without interfering with the positions of the power reception coil 118 and the spacer 340.

If the device 330 is inserted from the opening 201 towards the inside of the charging box 310, an output state of the optical sensor 320 is switched if the power reception coil 132 and the spacer 340 cross the optical sensor 320. At this time, the power transmission side controller 151 turns on the LEDs of a display section 205 to indicate that the charging is enabled outside the charging box 310, and starts the power transmission.

By providing the optical sensor 320, it is possible to know the position of the device 330 at the inside of the charging box 310. Only one optical sensor 320 is arranged here; however, two optical sensors may be provided. The optical sensor may also be arranged near the opening 201. If two optical sensors 320 are provided, for example, optical sensors 320 are installed at the left and right sides. If sensor output states of the left sensor and the right sensor are different, by blinking the LEDs 205A and 205B, it is possible to prompt a user to place the device 330 at the optimum position.

### THIRD EMBODIMENT

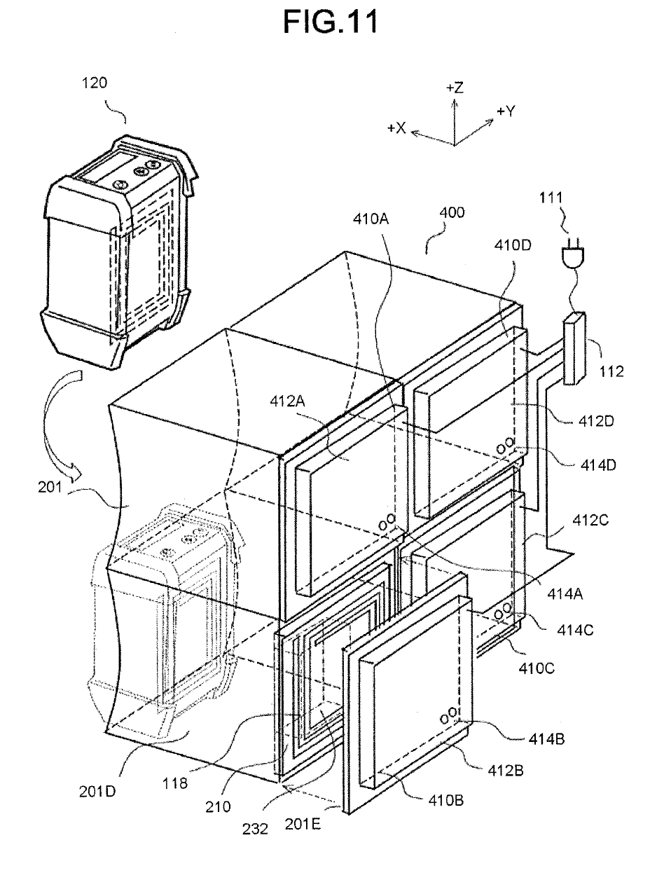

FIG. 11 shows the non-contact power transmission apparatus 400 according to the third embodiment. The non-contact power transmission apparatus 400 includes four (410A, 410B, 410C, 410D) charging boxes 200 of the first embodiment. The charging boxes 410B and 410C are arranged in the Y axis direction. Further, the charging box 410A is provided on the charging box 410B in the gravity direction, and the charging box 410D is provided on the charging box 410C in the gravity direction. Each of the charging boxes (410A to 410D) is provided with an opening 201 in the X axis direction and is configured in such a manner that the portable type thermal recording apparatus 120 can be inserted through the opening 201. The four charging boxes (410A to 410D) are fixed integrally and become a charging shelf.

The charging boxes (410A to 410D) have the same configuration. In order to make the internal configuration easily understood, in FIG. 11, a casing 412B is separated from the housing surface 201D. At the inside of the charging box 410B, the power transmission coil 118 is arranged at the housing surface 201E side. A spacer 232 made of resin is provided at the opening 201 side of the power transmission coil 118. The PC board 210 on which the power transmission coil 118 is provided and the PC board 176 on which the power reception coil 132 is provided can be kept parallel and the distance therebetween can be kept constant by the spacer 232.

The charging box 410B has the casing 412B having a clock input and output terminal 414B on the back surface 201E. Between the casing 412B and the back surface 201E, a power transmission circuit is built in. The clock input and output terminal 414B is connected to a power transmission controller in the power transmission circuit. Similarly, the charging boxes (410A, 410C, 410D) have clock input and output terminals (414A, 414C, 414D) respectively. The clock input and output terminals (414A to 414D) operate according to the same clock signal. In other words, a charging operation is performed in synchronization with the four charging boxes (410A, 410B, 410C, 410D).

By operating according to the same clock signal, generation of noise can be suppressed and the stable non-contact power transmission is enabled. By operating each of the charging boxes (410A to 410D) synchronously, a phase of radio wave transmitted from the power transmission coil 118 of each of the charging boxes (410A to 410D) is aligned, and the radio interference among the charging boxes can be suppressed.

The power transmission coil 118 of each of the charging boxes (410A to 410D) is formed on the Y-Z plane. The magnetic flux generated from the power transmission coil 118 is generated in the direction orthogonal to the gravity direction. The magnetic flux generated by each of the power transmission coils 118 is generated in the X axis direction. If the power transmission coil is provided on the X-Y plane and the charging boxes are stacked in the Z axis direction, the magnetic flux generated by the power transmission coil is directed in the Z axis direction, and thus the interference between the two power transmission coils may occur. As compared with the above case, in the third embodiment, it is possible to reduce radio interference among the charging boxes (410A to 410D).

Furthermore, the non-contact power transmission apparatus of the third embodiment has the same effect as that of the first embodiment. Also in the third embodiment, it is possible to include a function of detecting the position of the portable type thermal recording apparatus 120 by the optical sensor of the second embodiment.

If the four charging boxes (410A, 410B, 410C, 410D) charge the portable type thermal recording apparatuses 120 of the same type, the same spacer 232 is provided for four charging boxes (410A to 410D). It is not absolutely necessary to provide the same spacer 232 in all the four charging boxes (410A to 410D). As an example, the charging boxes 410A and 410B charge the portable type thermal recording apparatuses 120 described above, and the charging boxes 410C and 410D charge the portable type thermal recording apparatuses 121 different from the above-described portable type thermal recording apparatuses 120 in the shape of the housing. The charging boxes 410A and 410B are provided with the above-mentioned spacer 232, and the charging boxes 410C and 410D are provided with a spacer suitable for the shape of the housing of the portable type thermal recording apparatus 121. As a result, it is possible to simultaneously charge different types of the portable type thermal recording apparatuses.

In addition to the portable type thermal recording apparatus, the non-contact power transmission apparatus may also use a mobile phone, a PDA (Personal Data Assistance), an electric shaver, and the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A non-contact power transmission apparatus, comprising a device and a power supply device, wherein
the device comprises:
a first insulating substrate having a planar shape and having a first conductive layer on a surface of the first insulating substrate, the first conductive layer shaped as a power reception coil having a first coil pattern; and
the power reception coil arranged to generate induced current by magnetic flux in a first direction crossing a gravity direction, wherein an outer shape of the first coil pattern has a first width in a second direction crossing the first direction and the gravity direction, and
the power supply device comprises:
a second insulating substrate having a planar shape and having a second conductive layer on a surface of the second insulating substrate, the second conductive layer shaped as a power transmission coil having a second coil pattern;
the power transmission coil arranged to generate the magnetic flux in the first direction, wherein an outer shape of the second coil pattern has a second width larger than the first width in the second direction;
a support section configured to support the second insulating substrate in parallel with the first insulating substrate; and
a conductive housing having inside the power transmission coil and the support section, and having an opening to which the device can be inserted.

2. The non-contact power transmission apparatus according to claim 1, wherein the device comprises one of a thermal recording apparatus, a mobile phone, a personal data assistant, or an electric shaver.

3. The non-contact power transmission apparatus according to claim 1, wherein the device includes a protrusion, and the power reception coil is supported on the protrusion.

4. A power supply device for transmitting electric power in a non-contact manner to a device comprising a first insulating substrate having a planar shape and having a first conductive layer on a surface of the first insulating substrate, the first conductive layer shaped as a power reception coil having a first coil pattern, and the power reception coil arranged to generate induced current by magnetic flux in a first direction crossing a gravity direction, wherein an outer shape of the first coil pattern has a first width in a second direction crossing the first direction and the gravity direction, the power supply device comprising:
a second insulating substrate having a planar shape and having a second conductive layer on a surface of the second insulating substrate, the second conductive layer shaped as a power transmission coil having a second coil pattern;
the power transmission coil arranged to generate the magnetic flux in the first direction, wherein an outer shape of the second coil pattern has a second width larger than the first width in the second direction;
a support section configured to support the second insulating substrate in parallel with the first insulating substrate; and
a conductive housing having inside the power transmission coil and the support section, and having an opening to which the device can be inserted.

5. The power supply device according to claim 4, further comprising:
a first capacitor connected to the power transmission coil;
a power transmission section configured to transmit electric power via the power transmission coil and the first capacitor;
a sensor configured to detect a position of the power transmission coil; and
a controller configured to control the power transmission section in response to a sensor output indicating a position of the power transmission coil.

6. The power supply device according to claim 5, wherein the sensor comprises a first sensor, and a second sensor separated from the first sensor.

7. The power supply device according to claim 4, further comprising a spacer configured to keep a distance constant between the power transmission coil and the power reception coil in the first direction.

8. The power supply device according to claim 7, wherein the spacer contacts the second insulating substrate.

9. The power supply device according to claim 8, wherein when the device is inserted into the conductive housing to contact the spacer, the spacer contacts the first insulating substrate.

10. The power supply device according to claim 7, wherein the spacer has an area larger than an area of the power reception coil.

11. The power supply device according to claim 5, further comprising a spacer configured to keep a distance constant between the power transmission coil and the power reception coil in the first direction.

12. The power supply device according to claim 4, wherein
a plurality of the housings is integrally provided, and
at least two or more of the plurality of housings are stacked in the gravity direction.

13. The power supply device according to claim 12, wherein all of the housing of the plurality of housing are oriented in a same direction.

14. The power supply device according to claim 4, wherein the housing comprises a plurality of metal plates.

15. The power supply device according to claim 14, wherein the metal plates comprise a metal selected from the group consisting of steel, aluminum and copper.
